(19) United States
(12) Patent Application Publication
(10) Pub. No.: US 2026/0065330 A1
(43) Pub. Date: Mar. 5, 2026

(54) Cardboard Feedback Station with Encapsulated Pedal System for Business Use

(71) Applicants: Mathieu Marie L. Donnet, Brussels (BE); Guillaume Marie L. Donnet, Overijse (BE)

(72) Inventors: Mathieu Marie L. Donnet, Brussels (BE); Guillaume Marie L. Donnet, Overijse (BE)

(21) Appl. No.: 19/317,728

(22) Filed: Sep. 3, 2025

Related U.S. Application Data
(60) Provisional application No. 63/690,330, filed on Sep. 4, 2024.

(51) Int. Cl. G06Q 30/0282; G05G 1/01; G05G 1/46; G06F 3/02; G08B 13/14

(52) U.S. Cl. CPC G06Q 30/0282; G05G 1/01; G05G 1/46; G06F 3/02; G08B 13/14

(57) ABSTRACT

A recyclable feedback station comprising a cardboard housing (1) with one or more foot-operated pedals (3) encapsulated within the housing to collect user input in a hygienic and anonymous manner. Encapsulation (5) prevents direct contact with internal components while ensuring actuation is visible from the front but concealed laterally for user privacy. The housing (1) includes a stabilizing base (FIG. 3) configured to resist tilting during repeated use and may be shipped flat-packed for efficient transport. A compartment (4) may securely house a computing device (2), such as a tablet, the compartment being configured to accommodate devices of varying sizes including reused or heterogeneous tablets, thereby supporting sustainability. The compartment (4) is assembled without glue or bolts. The device (2) may include an integrated alarm system to prevent unauthorized removal. The station supports deployment across industrial, healthcare, service, and retail environments for sustainable and anonymous feedback collection.

### Cross-Reference to Related Applications

This application claims the benefit of U.S. Provisional Application No. 63/690,330, filed on Sep. 4, 2024, the entire contents of which are incorporated herein by reference.

### FIELD OF THE INVENTION

The invention relates to feedback collection systems, and more particularly to recyclable and hygienic stations comprising a cardboard housing with foot-operated pedals encapsulated within the structure, suitable for deployment in industrial, healthcare, retail, and service environments.

### BACKGROUND OF THE INVENTION

Existing feedback collection methods such as paper surveys, touchscreen kiosks, or plastic push-button devices suffer from drawbacks including hygiene risks, high costs, and unsustainable material use.

In addition, many conventional systems expose user actions to others, reducing anonymity and discouraging participation.

There is a need for a recyclable, low-cost, hygienic feedback station that ensures privacy, is easy to deploy, and can be securely paired with a processing device without permanent fasteners such as glue or bolts.

### SUMMARY OF THE INVENTION

The invention provides a feedback station comprising a cardboard housing (1) and one or more foot-operated pedals (3) encapsulated within the housing (1). Encapsulation (5) prevents direct user contact with internal components, ensuring hygiene.

The housing (1) is made of recyclable or biodegradable cardboard, and may be foldable for transport and storage. The housing (1) is replaceable and recyclable after a predetermined period of use, and includes a stabilizing base as illustrated in FIG. 3, designed to resist tilting, in some embodiments withstanding at least 20 Newtons of lateral force.

The pedal system (3) may include two pedals for binary responses or three or more for multiple-choice input. Each pedal (3) transmits motion to a sensor via a concealed linkage (FIG. 2). The pedals (3) are arranged so that they are visible from the front for actuation but concealed from lateral view by the housing (1), thereby preserving anonymity of user input.

In some embodiments, the station further comprises a compartment (4) configured to house a computing device (2), such as a tablet. The compartment (4) is configured to accommodate computing devices of varying sizes, including tablets obtained from heterogeneous sources, thereby enabling reuse of existing devices and supporting sustainability. The compartment (4) is assembled without glue or bolts, relying instead on mechanical interlocks, folds, or other recyclable cardboard joining methods, thereby improving sustainability and reducing cost. The computing device (2) may include an integrated alarm system to prevent unauthorized removal from the housing (1).

The invention supports deployment across industrial, healthcare, retail, and service environments, where anonymous, hygienic, and sustainable feedback collection is critical.

### BRIEF DESCRIPTION OF THE DRAWINGS

FIG. 1 is a perspective view of a feedback station with cardboard housing (1), computing device (2), pedals (3), and compartment (4).

FIG. 2 is a lateral view showing the concealment of the pedals (3) within the housing (1) ensuring privacy while voting.

FIG. 3 is a bottom view of the housing (1), illustrating a stabilizing base configured to contact the ground at its extremities while leaving an open central section to accommodate the pedals (3), thereby resisting tilting or sliding during use.

FIG. 4 is a schematic top view of the pedal system (3) mounted to the cardboard housing (1), the actuation mechanism being protected by the encapsulation (5).

### DETAILED DESCRIPTION OF THE PREFERRED EMBODIMENTS

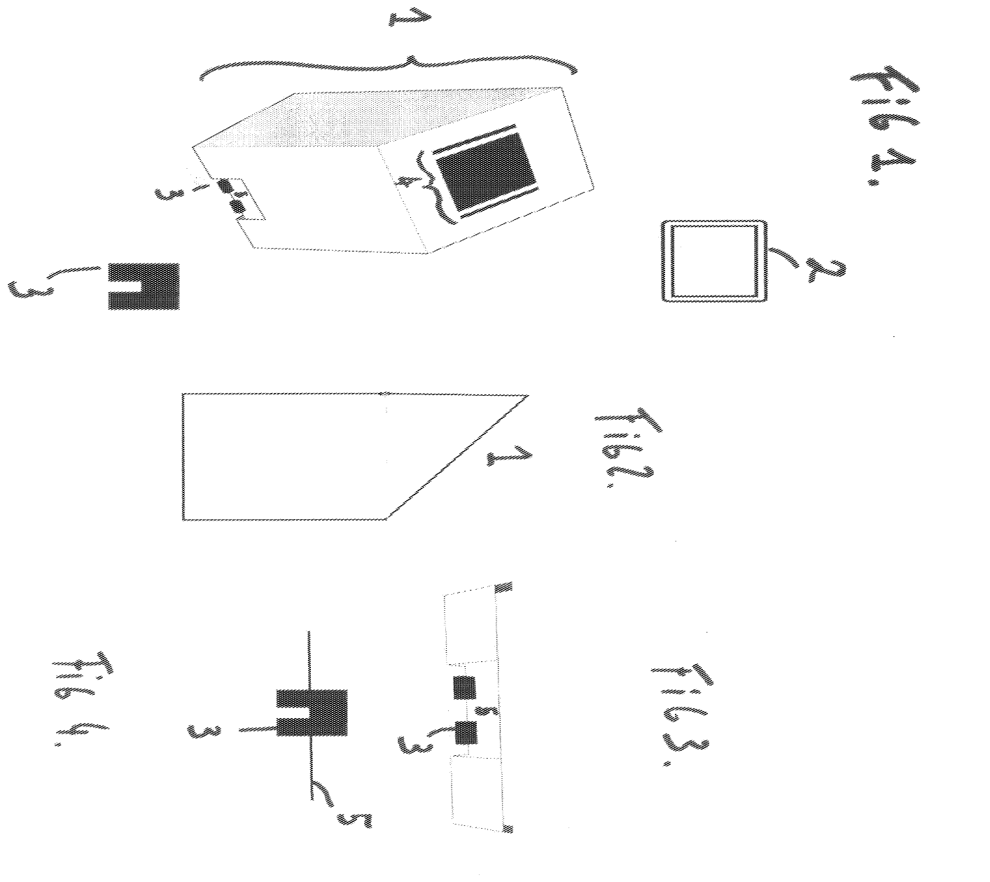

Referring to FIG. 1, the feedback station includes a recyclable cardboard housing (1) with a compartment (4) for securely housing a computing device (2), such as a tablet. The compartment (4) is configured to accommodate computing devices of varying sizes, including tablets obtained from heterogeneous sources, thereby enabling reuse of existing devices and supporting sustainability. The device (2) may display survey options and record signals transmitted from the pedals (3). The compartment (4) is assembled without glue or bolts, using mechanical interlocking features that allow secure positioning while preserving recyclability.

As shown in FIG. 2 and FIG. 4, the pedals (3) are encapsulated within the housing (1) by an enclosure (5), preventing direct user contact with internal components. Actuation of a pedal (3) is detected by a sensor, with the signal being recorded as user input. The pedals (3) are arranged to be visible from the front for actuation but hidden from side view, preserving the anonymity of user input.

FIG. 3 illustrates the stabilizing features of the housing (1), configured to resist tilting or sliding. In some embodiments, the housing (1) withstands a lateral force of at least 20 Newtons without toppling.

The housing (1) is replaceable and recyclable, and may be shipped flat-packed for efficient transport.

In certain embodiments, the computing device (2) may be paired with an alarm system that activates when removed without authorization, protecting both physical hardware and collected data.

The system may be deployed in a wide range of environments, including but not limited to industrial facilities, healthcare institutions, service environments, retail stores, and other public or private locations where anonymous, hygienic, and sustainable feedback collection is desired.

In another aspect, a method for collecting feedback comprises: providing a user with a foot-operated pedal system (3) encapsulated within a recyclable cardboard housing (1), transmitting the user's input to a processing device (2) housed in compartment (4), and recording feedback electronically while protecting components via fixed encapsulation (5) and optional alarm activation.

1. A feedback station comprising a cardboard housing (1) and at least one foot-operated pedal input system (3) encapsulated within the housing (1), the pedal input system (3) being configured to collect user responses in a hygienic and anonymous manner.

2. The feedback station of claim 1, wherein the cardboard housing (1) is formed of recyclable or biodegradable material.

3. The feedback station of claim 1, wherein the pedal input system (3) comprises two pedals as illustrated in FIG. 1, the pedals corresponding to opposite responses.

4. The feedback station of claim 1, wherein the pedal input system (3) comprises three or more pedals corresponding to multiple response options.

5. The feedback station of claim 1, wherein the encapsulation (5) prevents direct user contact with internal pedal components, as illustrated in FIG. 3.

6. The feedback station of claim 1, wherein the housing (1) is configured to be replaceable and recyclable after a predetermined period of use.

7. The feedback station of claim 1, wherein the housing (1) comprises a stabilizing base as illustrated in FIG. 3 to prevent tilting or sliding during operation.

8. The feedback station of claim 1, wherein the station is configured to receive user input exclusively by foot operation, without requiring hand contact.

9. The feedback station of claim 1, wherein each pedal (3) transmits motion to a sensor through a linkage concealed entirely within the housing (1), as illustrated in FIG. 4, and wherein the pedals (3) are visible from the front for actuation but concealed from lateral view by the housing (FIG. 2.-1) to preserve anonymity of user input.

10. A recyclable user feedback system comprising a cardboard structure (1) formed of recyclable material, a foot-operated input device (3) positioned within the structure, a mechanical linkage transmitting user actuation to a sensor, and the structure being configured for sustainable deployment and replacement.

11. The feedback station of claim 1, wherein the cardboard housing (1) is foldable or flat-packable for shipping and storage.

12. The feedback station of claim 1, further comprising an integrated alarm system activated in response to unauthorized removal of an associated computing device (2), as illustrated in FIG. 1, thereby enhancing the security of collected feedback data.

13. The feedback station of claim 7, wherein the housing (1) is designed to resist toppling when subjected to a lateral force of at least 20 Newtons.

14. The feedback station of claim 1, wherein the station is deployed in an industrial facility for collecting operator feedback.

15. The feedback station of claim 1, wherein the station is deployed in a service environment for collecting customer or employee feedback.

16. The feedback station of claim 1, wherein the station is deployed in a healthcare facility for collecting patient or staff feedback.

17. The feedback station of claim 1, wherein the station is deployed in a retail environment for collecting customer feedback in large commercial stores or supermarkets.

18. The feedback station of claim 1, further comprising a compartment (4) configured to securely house a computing device or processing unit with a display screen, the compartment (4) being assembled without glue or bolts, as illustrated in FIG. 1.

19. The feedback station of claim 18, wherein the compartment (4) is configured to accommodate computing devices of varying sizes, including tablets obtained from heterogeneous sources, thereby enabling reuse of existing devices and supporting sustainability.

20. A method for collecting feedback in an industrial, business, retail, or healthcare environment, comprising: providing a user with a foot-operated pedal system (3) associated with feedback options, the pedal system being encapsulated within a cardboard housing (1); transmitting the user's feedback selections to a processing unit (2); and recording the feedback in an electronic format while protecting the pedal system (3) and associated components from tampering through physical encapsulation (5) and optional alarm activation.
